(19) United States
(12) Patent Application Publication
(10) Pub. No.: US 2011/0274781 A1
(43) Pub. Date: Nov. 10, 2011

(54) Method for Producing Cured Milk to Feed Milk-Fed Animals

(75) Inventor: Claudette Berger, Mennecy (FR)

(73) Assignee: DANISCO A/S, Copenhagen K (DK)

(21) Appl. No.: 13/143,229

(22) PCT Filed: Jan. 7, 2010
(86) PCT No.: PCT/FR2010/050018

§ 371 Date: Jul. 5, 2011

(30) Foreign Application Priority Data
Jan. 7, 2009 (FR) 0950066

(51) Int. Cl. A23C 9/12

(52) U.S. Cl. 426/2; 426/61; 426/580

(57) ABSTRACT

The invention relates to a method for producing cured milk for feeding milk-fed animals, particularly livestock.

The invention relates to a method for producing cured milk for feeding milk-fed animals and notably livestock.

For feeding livestock, and in particular for feeding calves, some farmers use “yoghurt milk” or milk with yoghurt. Yoghurt milk is a raw, cold milk, obtained from the milking of the whole herd, which ferments as a result of supplying lactic acid bacteria to obtain a product that is more easily assimilated, intended for feeding calves. The lactic acid bacteria are supplied by adding one or more yoghurts to the milk. Before the first calvings, the farmer mixes it in a milk tank and this mixture will be used throughout the period of suckling of the calves. He prepares a vat sludge, adds yoghurts, leaves to ferment for a day or overnight, then tops up the tank, waits another day and it is ready for use. Every day he replaces the amount used as a priority with marketable or nonmarketable milk that does not contain antibiotics. The pH of the milk rises owing to the supply of fresh milk and fermentation thus resumes on account of the residues of seeded milk, called “vat sediment”. He thus makes successive subcultures.

The yoghurt milk technique makes it possible to simplify the calves' milk phase. According to a predefined feeding plan, the farmer combines efficiency and simplicity of the technique to be employed. There is in consequence a reduction of the farmer's work load as he only distributes the yoghurt milk once a day, the yoghurt milk being freely accessible to the calves throughout the day. In contrast, the calf fed with unfermented milk must receive the milk at the temperature of the mother directly after each of the two daily milkings. If the milk is at a temperature below 35° C., the calf suffers from diarrhea connected with problems of digestion.

The distribution of yoghurt milk, which can be cold, allows a certain flexibility during liquid feeding. The latter can be disconnected from milking and a single distribution per day is sufficient.

Moreover, a decrease in diarrhea is found when using yoghurt milk. The equipment is not expensive. Calves raised using the yoghurt milk technique have very good growth during the milk phase.

However, the external temperature is still the limiting factor for this technique, notably in the control of fermentation. The rate of fermentation of the milk is strongly dependent on the ambient temperature. In winter, the ambient temperature is too low, preventing fermentation, and in summer, if the ambient temperature is too high there is a marked drop in pH which causes not only a decrease of the calf's appetite for the yoghurt milk but also leads to formation of yoghurt milk that is so viscous that it obstructs the systems for distribution of the milk by means of feeders with teats.

To solve these problems and eliminate the seasonal effect, the effect of the method of subculture and the effect of fermentation on the quality of the milk produced, the inventors have developed a method for producing a cured milk by seeding with an inactivated ferment for animal feeding.

The present invention relates to a method for producing a cured milk for animal feeding, in which a milk vat is seeded with an inactivated ferment.

The cured milk thus obtained is more easily digested at ambient temperature than a milk that has not been seeded.

Typically, curing of the milk can take place at ambient temperature. The expression “ambient temperature” indicates that the temperature is not regulated. Typically the ambient temperature can vary according to the season. It can be between 4 and 50° C., preferably between 10 and 35° C. and even more preferably between 18 and 30° C.

The duration of curing can vary from minutes to 48 hours, preferably from 30 min to 24 hours and even more preferably between 1 hour and 10 hours.

Typically the cured milk has a pH between 6 and 7, preferably between 6.2 and 6.8, and even more preferably between 6.4 and 6.8.

Typically the cured milk has a viscosity between 5 cP and 3000 cP (i.e. from 0.005 to 3 Pa.s), or between 5 cP and 500 cP (i.e. from 0.005 to 0.5 Pa.s). Preferably, the viscosity of the cured milk is between 10 and 300 cP (i.e. from 0.01 Pa.s to 0.3 Pa.s), more preferably between 10 and 50 cP, and even more preferably between 10 and 30 cP.

Typically an inactivated ferment can be obtained by inactivation of the microorganisms of a ferment traditionally used for fermentation of milk.

Inactivation can greatly reduce the microorganisms' ability to reproduce without any appreciable effect on the enzymatic activity of the microorganisms. This is what makes curing of the milk possible while largely avoiding fermentation and subsequent acidification of the milk.

Typically, during inactivation of the microorganisms the number of microorganisms capable of reproducing can be reduced by a factor greater than X, where X is selected from the following values: 10⁴, 10⁵, 10⁶, 10⁷, 10⁸, 10⁹, 10¹⁰ or 10¹¹.

Typically, the microorganisms can be inactivated by a heat treatment. The microorganisms can for example be submitted to temperatures between 40° C. and 70° C.

Typically, the duration of the heat treatment will depend on the temperature used and the microorganisms to be inactivated and for example can be between 15 min and 96 hours.

The microorganisms can for example be submitted to temperatures between 60° C. and 70° C. for a time between 20 and 40 hours.

Other techniques for inactivation of microorganisms, such as ionization or inactivation with light, can also be used. The microorganisms can for example be inactivated by storage for long periods at temperatures and/or in the presence of humidity that do not permit the viability of the microorganisms to be maintained.

The microorganisms constituting the ferment can be yeasts and/or bacteria.

Advantageously, the microorganisms are lactic acid bacteria.

Typically the milk vat can contain only colostrum, a colostrum/milk mixture or only milk. Typically a colostrum/milk mixture can comprise between 30 and 70% (% v/v) of colostrum.

The milk used can be pasteurized or sterilized beforehand or can be the raw milk obtained directly after milking. Typically it can be cow, sheep, goat or buffalo milk. It can also be milk of vegetable origin, for example soya milk.

The milk used can be a milk reconstituted from powdered milk, from powdered colostrum, from a mixture of powdered milk and powdered colostrum, or from a powdered suckling feed (or milk substitute).

Typically the powdered suckling feed can be intended for breeding calves.

Typically the powdered milk or powdered colostrum can be obtained by lyophilization.

Typically the degree of reconstitution of the powder can be between 50 g/L and 300 g/L.

Typically the powder can be dissolved at a temperature between 50° C. and 70° C.

The reconstituted milk obtained can then be cooled to a temperature below 47° C., preferably between 37° C. and 45° C., more preferably between 40° C. and 45° C. and can be seeded at this temperature with an inactivated ferment.

The use of powder gives the farmer great flexibility with respect to administration of fermented milk to the animals, as the farmer can completely dissociate the administration of fermented milk from the milking.

One object of the invention relates to a kit comprising separately:
an inactivated ferment; and
a powdered milk, a powdered colostrum, a mixture of powdered milk and powdered colostrum, or a powdered suckling feed.

Typically, a person skilled in the art can use the two components of the kit on the one hand for producing a milk reconstituted with powdered milk, powdered colostrum, a mixture of powdered milk and powdered colostrum, or powdered suckling feed and on the other hand can then seed the reconstituted milk with the inactivated ferment.

Another object of the invention relates to a kit comprising separately:
an inactivated ferment; and
a frozen milk, a frozen colostrum, a mixture of frozen milk and frozen colostrum, or a frozen milk reconstituted from suckling feed.

Alternatively, an object of the invention relates to a composition comprising an inactivated ferment mixed or not with a powdered milk, a powdered colostrum, a mixture of powdered milk and powdered colostrum, or a powdered suckling feed.

The milk used can be a milk that is marketable or nonmarketable.

Typically the cured milk can be intended for animal feeding, preferably of young animals and even more preferably of young animals for breeding. For example, the cured milk can be intended for feeding calves and can be obtained from cow milk or colostrum.

Advantageously, the method of production according to the invention can be implemented at the farm of the farmer of the livestock that is fed with the cured milk obtained by the method.

The inactivated ferment can be either in the form of powder or pellets, or in the form of suspension. For example, application FR2869622 describes pellets for direct seeding. The bacteria of the ferment can be in dry, lyophilized or frozen form. In the case of dry, lyophilized or frozen forms, the inactivated ferment can be made into a suspension before being used for seeding the milk vat.

The ferment can be rehydrated, re-suspended in an aqueous medium or in milk before seeding.

These types of ferment have the advantage that they can be introduced directly in the medium to be treated or to be seeded. This greatly limits the risks of contamination of the cured milk in an environment that is not controlled from the microbiological standpoint. Typically the ferments employed according to the invention can contain various additives, added during drying or during lyophilization of the bacteria.

The yeasts usable in this method are for example of the type Saccharomyces ssp., preferably Saccharomyces cerevisiae and/or Saccharomyces boulardii, Kluyveromyces spp., Debaryomyces spp.

Typically the lactic acid bacteria contained in the ferment are those belonging to the genera Lactococcus, Streptococcus, Lactobacillus, Leuconostoc, Pediococcus, Bifidobacterium, Brevibacterium, Carnobacterium, Enterococcus, Micrococcus, Vagococcus, Staphylococcus, Bacillus, Kocuria, Arthrobacter, Propionibacterium and Corynebacterium. These lactic acid bacteria can be used alone or mixed. Preferably the ferment will comprise the strain Streptococcus thermophilus and/or Lactobacillus delbrueckii ssp for example Lactobacillus delbrueckii bulgaricus, Lactobacillus delbrueckii lactis. Bacteria of the type Propionibacterium acidilactici, Propionibacterium jensenii, Propionibacterium freudenreichii and Propionibacterium acidipropionici can advantageously be used.

Advantageously, the ferment can also comprise Lactobacillus acidophilus, Lactobacillus casei, Lactobacillus paracasei, Lactobacillus plantarum, Lactobacillus salivarius, Lactobacillus fermentum, Bifidobacterium bifidum, Bifidobacterium longum, Bifidobacterium lactis, Bifidobacterium infantis, Bifidobacterium brevis or a mixture of several of these microorganisms.

Advantageously, the ferment used comprises independently or in combination lactic acid bacteria of the type Streptococcus thermophilus, Lactobacillus acidophilus, Bifidobacterium lactis and Lactobacillus delbrueckii ssp.

More advantageously, the ferment used comprises independently or in combination strains of Streptococcus thermophilus deposited according to the Treaty of Budapest in the name of Rhodia Food, ZA of Bruxiéres, 86220 Dange-Saint-Romain, France, under number I-2423 on 5 Apr. 2000 in the Collection Nationale des Cultures de Microorganismes (or CNCM, 25 rue du Dr Roux, 75724 Paris) or deposited according to the Treaty of Budapest in the name of Danisco France, 20 rue de Brunel, 75017 Paris, under numbers I-3782 and I-3783 on 3 Jul. 2007 in the CNCM.

In another advantageous embodiment, the ferment used further comprises, independently or in combination, strains of Lactobacillus acidophilus, Bifidobacterium lactis, Lactobacillus delbrueckii ssp deposited according to the Treaty of Budapest in the name of Danisco France, 20 rue de Brunel, 75017 Paris, respectively under numbers I-3784, I-3780 and I-3781 on 3 Jul. 2007 in the CNCM.

Preferably, before inactivation, the ferment used comprises at least 20% CFU out of the total number of CFU of the ferment of Streptococcus thermophilus, preferably at least 40% CFU. The expression “CFU” denotes “colony forming unit”.

Advantageously, before inactivation, the ferment used comprises at least 1% CFU out of the total number of CFU of the ferment of Lactobacillus acidophilus and/or of Bifidobacterium ssp, and preferably at least 3% CFU.

Typically, for the method of curing milk according to the invention, it is possible to use a ferment comprising lactic acid bacteria, which comprises before inactivation, per liter of milk to be seeded, between 10⁸ and 10¹¹ CFU, preferably between 10⁹ and 5 10¹⁰ CFU, and even more preferably between 5 10⁹ and 10¹⁰ CFU.

According to another embodiment, the method of curing can employ an inactivated ferment in combination with an activated ferment, comprising for example lactic acid bacteria or probiotics.

Excellent results were obtained with a ferment comprising a mixture of bacteria belonging to the genus Streptococcus with bacteria belonging to the genus Lactobacillus.

Typically the milk curing time will be between 0.1 and 48 hours, preferably between 30 min and 24 hours and even more preferably between 1 hour and 10 hours.

Typically the cured milk obtained can have a pH between 6 and 7, preferably between 6.2 and 6.8, and even more preferably between 6.4 and 6.7.

The cured milk obtained can have a viscosity between 5 cP and 3000 cP, preferably between 5 cP and 500 cP, more preferably between 10 and 50 cP and even more preferably between 10 and 30 cP.

Typically the viscosity of the cured milk can be measured using any conventional method of viscosity measurement known by a person skilled in the art. For example, the viscosity of the cured milk can be measured using a viscometer of the Brookfield DV-II+type, applying the protocols described in Table 1 depending on the range of viscosity of the product.

TABLE 1
Protocols for measurements of viscosity as a function
of the range of viscosity of the product.

| | Protocol A | Protocol B |
|---|---|---|
| Type of products | products with liquid | products with gelled |
| measured | texture | texture |
| Sample preparation | Light homogenization | Mixing with 20 turns |
| | with 3 turns of | of teaspoon |
| | teaspoon | |
| T° C. of measurement | +8° C. | +8° C. |
| Type of container and | 200 ml of product in a | 100 ml of product in a |
| volume measured (size, | 250-ml beaker | 120-ml glass yoghurt |
| geometry and volume) | | pot |
| Geometry of spindle | Disk RV1 | Disk RV3 |
| Rotary speed of | 100 revolutions per | 10 revolutions per |
| spindle | minute (or rpm) | minute (or rpm) |
| Viscosity range | 10-100 cP | 100-10000 cP |

The measurement is read after 20 seconds of rotation of the spindle in each of the protocols.

Typically during the method for producing cured milk according to the invention, a person skilled in the art can add additives to the milk vat such as vitamins, growth factors, autolyzates of yeasts, amino acids, mineral salts, essential oils, colorants—preferably natural, enzymes, soluble fibers, vegetable extracts, slow or fast sugars. Said addition can take place before, during or after curing of the milk.

Another object of the invention is a cured milk that can be obtained according to a method of curing of the invention.

Typically a cured milk according to the invention can be intended for animal feeding, preferably of animals for breeding.

Typically a cured milk according to the invention can have a pH between 6 and 7, preferably between 6.2 and 6.8, and even more preferably between 6.4 and 6.7.

Typically a cured milk according to the invention can have a viscosity between 5 cP and 3000 cP, preferably between 5 cP and 500 cP, more preferably between 10 and 50 cP and even more preferably between 10 and 30 cP.

The invention also relates to the use of inactivated ferment for curing milk.

The invention also relates to a method for feeding animals with cured milk in which the cured milk is produced according to a method of production as described above.

The present invention will be better illustrated below by means of the following example. This example is given purely for illustrating the object of the invention, and does not in any way constitute a limitation thereof.

### EXAMPLE

A control batch of several calves were fed with a cured milk for 17 hours at ambient temperature with a live ferment composed of strains of Streptococcus thermophilus and Lactobacillus acidophilus. A second batch of calves of the same age was fed with the same ferments but the microorganisms were inactivated by a heat treatment (65° C. for 36 hours).

No diarrhea occurred in calves fed with the cured milk. The two batches of calves showed identical behavior and the growth performance is identical.

The pH of the cured milk obtained after 17 hours of curing at 25° C. is almost identical to the pH of the milk before curing.

The use of the cured milk according to the invention makes it possible to obtain a milk for feeding calves that can be distributed on one occasion and at ambient temperature and whose pH is completely controlled.

1. A method for producing a cured milk for animal feeding, in which a milk vat is seeded with an inactivated ferment.

2. The method as claimed in claim 1, wherein the inactivated ferment comprises microorganisms inactivated by a heat treatment.

3. The method as claimed in claim 1, wherein curing of the milk takes place at ambient temperature.

4. The method as claimed in claim 1, wherein the viscosity of the cured milk is between 10 and 300 cP, more preferably between 10 and 50 cP, and even more preferably between 10 and 30 cP.

5. The method as claimed in claim 1, wherein the pH of the cured milk is between 6 and 7, preferably between 6.2 and 6.8, and even more preferably between 6.4 and 6.8.

6. The method as claimed in claim 1, wherein the milk vat is a vat of milk reconstituted from powdered milk, from powdered colostrum, from a mixture of powdered milk and powdered colostrum, or from a powdered suckling feed.

7. The method as claimed in claim 1, wherein the ferment comprises inactivated lactic acid bacteria.

8. The method as claimed in claim 7, wherein the lactic acid bacteria comprised in the ferment are lactic acid bacteria belonging to the genus Lactococcus, Streptococcus, Lactobacillus, Leuconostoc, Pediococcus, Bifidobacterium, Brevibacterium, Carnobacterium, Enterococcus, Micrococcus, Vagococcus, Staphylococcus, Bacillus, Kocuria, Arthrobacter, Propionibacterium or Corynebacterium.

9. The method as claimed in claim 7, wherein the inactivated ferment used comprises, independently or in combination, lactic acid bacteria of the type Streptococcus thermophilus, Lactobacillus acidophilus, Bifidobacterium lactis and Lactobacillus delbrueckii ssp.

10. The method as claimed in claim 7, wherein the inactivated ferment used comprises, independently or in combination, strains of Streptococcus thermophilus deposited under number I-2423 on 5 Apr. 2000 in the CNCM or deposited under numbers I-3782 and I-3783 on 3 Jul. 2007 in the CNCM.

11. The method as claimed in claim 7, wherein the inactivated ferment used comprises, independently or in combination, strains of Lactobacillus acidophilus, Bifidobacterium lactis and Lactobacillus delbrueckii ssp deposited respectively under numbers I-3784, I-3780 and I-3781 on 3 Jul. 2007 in the CNCM.

12. The method as claimed in claim 1, wherein the ferment used comprises, before inactivation, at least 20% CFU out of the total number of CFU of ferment of Streptococcus thermophilus, preferably at least 40% CFU.

13. The method as claimed in claim 1, wherein the ferment used comprises, before inactivation, at least 1% CFU out of the total number of CFU of ferment of Lactobacillus acidophilus and/or of Bifidobacterium ssp, and preferably at least 3% CFU.

14. The method as claimed in claim 1, wherein the inactivated ferment comprises probiotic microorganisms such as Lactobacillus acidophilus, Lactobacillus casei, Bifidobacterium bifidum, Bifidobacterium longum, Bifidobacterium lactis, Bifidobacterium infantis or a mixture of several of these microorganisms.

15. A cured milk obtained by a method of production as claimed in claim 1.

16. (canceled)

17. A method for feeding animals with cured milk in which the cured milk is produced according to a method of production as claimed in claim 1.

18. A kit comprising separately:
an inactivated ferment; and
a powdered milk, a powdered colostrum, a mixture of powdered milk and powdered colostrum, or a powdered suckling feed.

19. A kit comprising separately:
an inactivated ferment; and
a frozen milk, a frozen colostrum, a mixture of frozen milk and frozen colostrum, or a frozen milk reconstituted from suckling feed.

20. A composition comprising an inactivated ferment and a powdered milk, a powdered colostrum, a mixture of powdered milk and powdered colostrum, or a powdered suckling feed.
